(19) United States
(12) Patent Application Publication
(10) Pub. No.: US 2006/0196444 A1
(43) Pub. Date: Sep. 7, 2006

(54) Animal treat and method of making same, and containers for holding an improved animal treat

(75) Inventors: Faith Radcliffe, Cranberry Township, PA (US); Jeffrey S. Lang, Venango, PA (US)

Correspondence Address: KIRKPATRICK & LOCKHART NICHOLSON GRAHAM LLP, 535 SMITHFIELD STREET, PITTSBURGH, PA, 15222, US

(73) Assignee: Dad's Products Company, Inc.

(21) Appl. No.: 11/069,250

(22) Filed: Mar. 1, 2005

(51) Int. Cl. A01K 29/00

(52) U.S. Cl. 119/710

(57) ABSTRACT

A food treat for an animal includes a pliable elongate shape formed from an ingredient mixture and having a length and a width, wherein the length is greater than the width. The elongate strip may be rolled along its length to provide a pliable rolled elongate animal food treat. Individual lengths of the rolled elongate shape may be unrolled and detached from the pliable rolled elongate animal food treat. A method of preparing a food treat for an animal also is disclosed including, for example, the step of combining a plurality of ingredients to form an ingredient mixture, the step of processing at least a portion of the ingredient mixture into a pliable flat shape, and the step of forming the flat shape into at least one pliable roll. A method of providing a food treat to an animal is further disclosed, wherein the method includes, for example, the step of unrolling a length of a pliable elongate rolled animal food treat, the step of detaching the length from the pliable elongate rolled animal food treat, and the step of providing the length to the animal.

### BACKGROUND

Many pet owners enjoy giving treats to their pets. Pet owners may treat their pets merely for the enjoyment of the pet and owner, or as a part of a training routine. For example, a pet owner may give a treat to his or her pet for performing a task, such as rolling over or retrieving a ball or other object. Conventional pet treats often include one or more of meat, animal hide, poultry, grain-based products, etc. Most such treats can be purchased only in pre-sized portions. For example, raw-hide-based treats and various meat-based treats often come in large, pre-sized single serving strips, while biscuits and other similar treats come in pre-sized chunks of various shapes and may be packaged in foil envelopes or plastic containers.

Conventional pet treats do not address certain needs of contemporary pet owners. For example, many pet owners provide treats to their pets while on the go, such as when walking their pets, and it can be inconvenient to carry a foil envelope or bulky plastic container during such activity. Thus, pet owners must either hold the treat containers while walking, or place them in a pocket or bag.

Today's pet owners also are becoming increasingly aware of their pets' diets. A pet owner may not want to provide a treat to their pet for performing a task or trick if the pet would consume more calories by ingesting the treat then it would expend completing the task. The limited array of predetermined portion sizes of existing treats do not give pet owners adequate control over their animals' diets. Pet owners may not be able to readily and accurately divide a dog biscuit, rawhide or other treat into smaller, reasonably sized portions to regulate their animals' caloric intakes. Even when a treat can be readily divided into smaller portions, the result can be messy, and may waste some portion of the treat.

Accordingly, there is a need for an animal treat that can be easily carried and accessed by pet owners while on the go with their pets. There also is a need for an animal treat available in variable portion sizes according to the dietary needs of the animal or the desires of the pet owner.

### SUMMARY

According to one aspect of the present disclosure, embodiments of novel food treats for an animal are provided. The food treat may be meat based or formed of some other suitable ingredient or combination of ingredients, e.g., vegetables or dairy products. The food treat may comprise a pliable elongated shape such as, for example, a strip having a length and a width, wherein the length is greater than the width. The elongate shape may be formed into a pliable roll. Desired lengths of the pliable rolled elongate animal food treat may be unrolled and detached from the roll, and then provided to a pet or other animal.

According to another aspect of the present disclosure, methods of preparing a pliable rolled elongate food treat for an animal are disclosed. Certain embodiments of the methods may comprise the step of combining a plurality of ingredients to form an ingredient mixture. In certain non-limiting embodiments of the method, the ingredient mixture may be extruded or otherwise processed into an elongate shape such as, for example, a strip, which may then be rolled to provide a rolled elongate animal food treat.

According to yet another aspect of the present disclosure, embodiments of a container for holding a pliable rolled food treat for an animal are disclosed. The container may comprise a first section. The first section may define a first hollow cavity. The container may also comprise a second section, which defines a second hollow cavity. The first hollow cavity and the second hollow cavity may form an enclosed region when the first section and the second section are placed together. A pliable rolled elongate animal food treat according to the present disclosure may be positioned within the enclosed region, the container thereby providing a convenient package for the rolled product.

According to another aspect of the present disclosure, embodiments of a container for holding food treat for an animal are disclosed. The container may comprise a hollow outer shell. The hollow outer shell may define a slot. The container may also comprise an edge adjacent to the slot. The edge may be serated and/or sharp. A pliable elongate rolled food treat according to the present disclosure may be positioned within the enclosed region. Also, the slot may be adapted to allow an unrolled portion of the pliable elongate rolled food treat to exit the hollow outer shell. The edge may be adapted to remove the unrolled portion.

According to a further aspect of the present disclosure, embodiments of methods of providing a food treat to an animal are disclosed. The methods may comprise the step of unrolling and detaching a desired portion of a roll of a pliable elongate animal food treat. The portion may have a desired length based on, for example, the size and/or weight of the animal to which the treat is to be provided. The methods may also comprise the step of providing the portion to the animal.

Various embodiments of the rolled elongate animal food treat disclosed herein may be easily transported, stored, and accessed by pet owners. A desired length of the rolled elongate food treat may be unrolled and detached from the roll, thereby allowing one to precisely tailor the size of the food treat to the size and/or weight of the animal, the animal's dietary requirements or restrictions, etc.

### BRIEF DESCRIPTION OF THE FIGURES

FIG. 1A is a side view of one embodiment of a rolled elongate food treat product according to the present invention;

FIG. 1B is a front view of the embodiment of FIG. 1A;

FIG. 2 is a side view of an embodiment of a container for a rolled elongate food treat product according to the present invention;

FIG. 3 is a side view of an additional embodiment of a container for a rolled elongate food treat product according to the present invention;

FIG. 4 is a side view of an additional embodiment of a container for a rolled elongate food treat product according to the present invention;

FIG. 5 schematically depicts an embodiment of a process according to the present invention; and

FIG. 6 schematically depicts an additional embodiment of a process according to the present invention.

### DESCRIPTION OF CERTAIN EMBODIMENTS

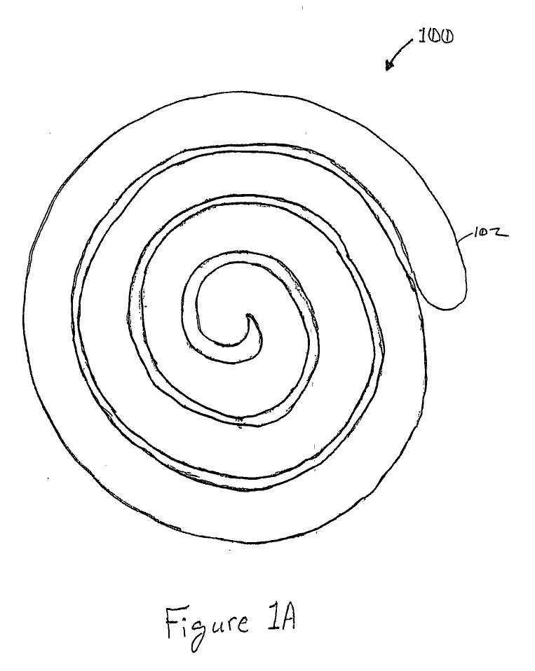

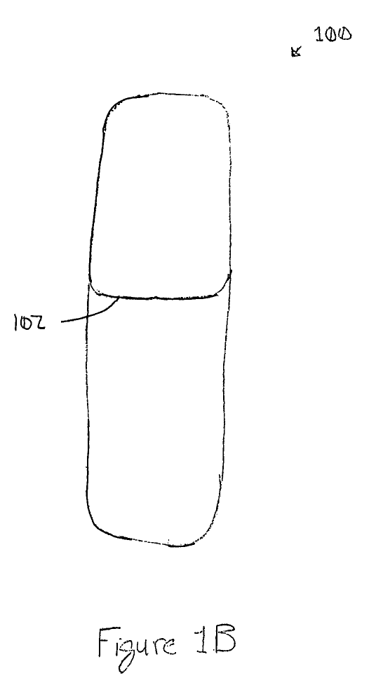

FIGS. 1A and 1B are views illustrating an embodiment 100 of a pliable rolled animal food treat product according to the present invention. As used herein, “pliable” means that the indicated item may be rolled and unrolled without causing any significant breakage of the item during such rolling and unrolling. The rolled product 100 may include an exposed end 102. In various embodiments, the rolled product 100 may be divided into portions of selected and varying lengths by unrolling the rolled product 100 beginning at the exposed end 102 and detaching all or a portion of the unrolled length by, for example, tearing or cutting. In various embodiments, the rolled product 100 may include indentations or perforations to facilitate tearing or cutting. The rolled product 100 may be made of any suitable ingredient or mixture of ingredients. For example, the rolled product 100 may be formed of a meat-based mixture including beef, chicken, turkey, tuna, lamb, bacon and/or pork. In various other embodiments, the rolled product 100 may be formed of a vegetable-based mixture including, for example, peas or carrots. Other embodiments of the rolled product 100 may be formed of a dairy mixture including, for example, milk, cheese or cream.

The rolled product 100 may be formed by producing a pliable elongate shape, such as a rectangular strip, and then rolling the shape. The elongate shape may have any desired width, thickness, length, and overall shape suitable for forming into a roll and that is desirable based on the intended application for the product. The dimensions and shape of the elongate shape may be influenced by, for example, the size and/or dietary habits of the animal for which it is intended, the calorie content of a unit length of the elongate shape, and the desired size of the container into which the rolled shape will be placed and sold. For example, if intended for domestic dogs and cats, the rolled product 100 may be provided by rolling a thin strip of an animal food product having a length of between two and fourteen feet, preferably three feet, into a roll. The width of an embodiment of the rolled product 100 intended for domestic dogs and cats may be, for example, between one-half inch and four inches, preferably one inch. Also, the thickness of an embodiment of the rolled product may be, for example, between one eighth of one inch and one half of one inch. The rolled product 100 may be sold in a dispenser, for example one of containers 200, 300, 400 below or may be sold without a dispenser, for example, as a replacement roll to be placed in a previously purchased dispenser.

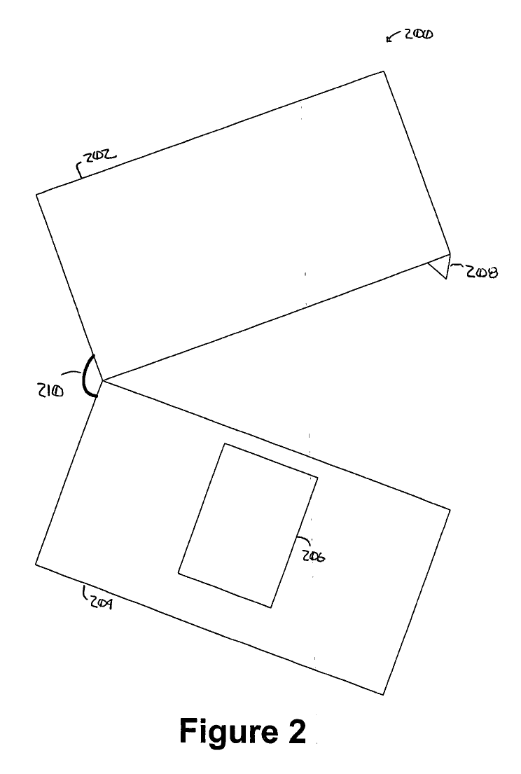

FIG. 2 depicts one possible embodiment of a container 200 for holding the rolled product 100. The container 200 may include a first section 202 and a second section 204. The first section 202 and second section 204 may be formed into any suitable shape and may be made from a plastic or any other suitable material. The first section 202 and second section 204 may be joined at their ends by hinge 210 or an equivalent structure that allows the two sections to be opened and closed. In various embodiments, the hinge 210 may comprise a strip of plastic or other suitable material. Each of the first section 202 and the second section 204 may be hollow. The first section 202 and the second section 204 may be rotated about the hinge 210 to bring the two sections together and form an enclosed region (not shown). The rolled product 100 may be placed in the enclosed region (not shown) and accessed by rotating the two sections about the hinge 210.

In certain embodiments, the container 200 may include a belt clip 206 for securing the container 200 to a belt or flap of clothing. Also, in various embodiments, the first section 202 may include a serrated and/or sharp edge 208 positioned opposite the hinge 210. The edge 208 may be used to detach an unwound portion of the rolled product 100. For example, the exposed end 102 of the rolled product 100 may be pulled from the container 200 until a desired length of the product 100 is exposed and a region of the product 100 is laid across the second section 204 under the edge 208. Closing the hinge 210 may cause the edge 208 to contact the rolled product 100. This may sever a portion of the rolled product 100, or may crease the rolled product 100, thereby making it easier to remove the portion by tearing the portion along the crease.

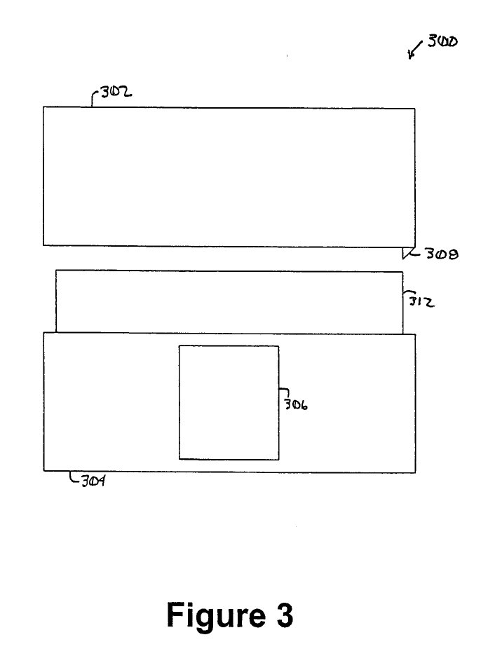

FIG. 3 shows an additional possible embodiment of a container 300 for holding the rolled elongate food treat product 100. The container 300 may include a first section 302 and a second section 304 which may be formed into any suitable shape. The first section 302 and second section 304 may be hollow, and when placed together may form an enclosed region (not shown) which may house the rolled product 100. The second section 304 may include a sleeve section 312. The sleeve section 312 may be sized to fit within the first section 302. One may close the container 300 by sliding the first section 302 onto the sleeve section 312. The container 300 may also include a belt clip 306 and serrated and/or sharp edge 308 which may be used, for example, in a manner similar to that described above with reference to FIG. 2.

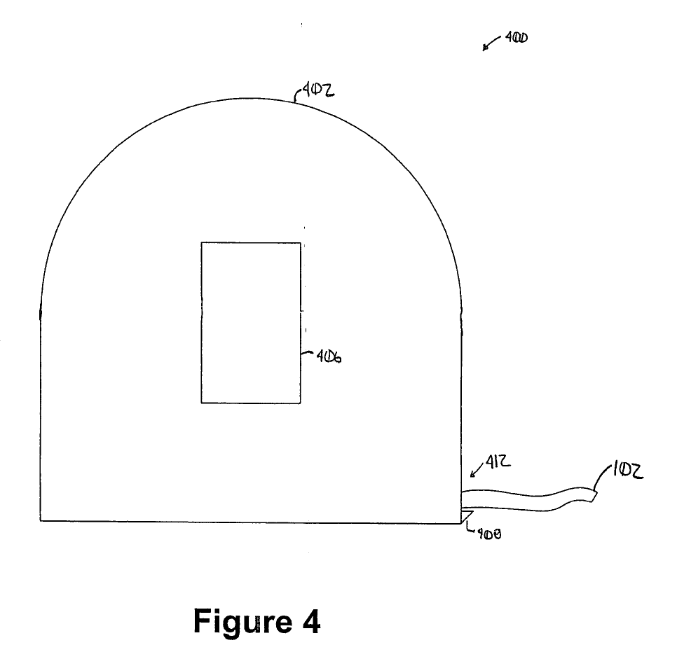

FIG. 4 shows yet another possible embodiment of a container 400 for holding the rolled elongate food treat product 100. The container 400 may include a hollow outer shell 402 for holding the rolled product 100. The hollow outer shell 402 may be formed in any suitable shape. A slot 412 may allow the exposed end 102 of the rolled product 100 to exit the outer shell 402. The container 400 may also include a sharp and/or serrated edge 408 for removing an unrolled portion of the rolled product 100. A portion of the exposed end 102 may be pulled through the slot 412 and then placed in contact with the edge 408, which may separate it from the rolled product 100. The container 400 may also include a belt clip 306 similar to the belt clips 206, 306 of containers 200 and 300.

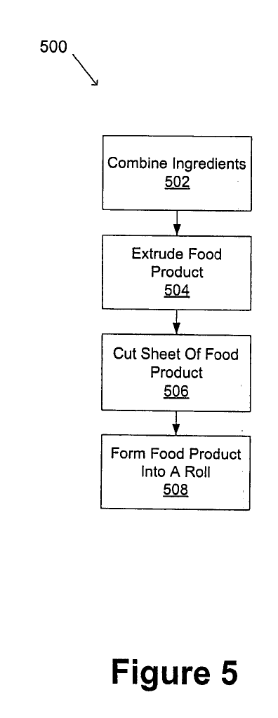

FIG. 5 is a flowchart schematically illustrating one non-limiting embodiment of a process 500 for preparing a rolled elongate food treat for an animal according to various embodiments of the present invention. At step 502, ingredients of the elongate food treat may be combined to form an ingredient mixture. It will be appreciated that the ingredients included in the ingredient mixture may be solid or liquid and may vary based on the form of the rolled product 100. For example, the ingredient mixture of a meat-based rolled product 100 may include one or more meat products, such as beef, chicken, turkey, tuna, lamb, bacon, pork, etc. The ingredient mixture of a vegetable-based rolled product 100 may include vegetables, such as, for example, carrots or peas. A dairy-based rolled product 100 may include one or more dairy products such as cheese, milk, etc. It will be appreciated that any of the ingredients of a rolled product 100, including those mentioned above, may be replaced by imitation flavors or ingredients. Also, some liquid ingredients, such as, corn syrup, high fructose corn syrup, glycerin, propylene glycol, corn oil, etc., may be common to one or more of the forms of the rolled product 100.

The combining of step 502 may include various component steps. For example, solid ingredients of the ingredient mixture may be initially ground into a powder. The grinding may be accomplished by hand, or by any suitable automated or semi-automated means. Solid and liquid ingredients of ingredient mixture may be mixed by hand, or by any automated or semi-automated means. The grinding and/or mixing may be done with any suitable commercial or consumer mixer, for example, those available from KELLY DUPLEX MILL & MANUFACTURING CO. The ingredient mixture also may be cooked, for example, using any suitable means such as baking, frying, etc. In various embodiments, combining and cooking may be performed simultaneously using any suitable equipment, for example, a jacketed dough mixer available from READCO MANUFACTURING. Those having ordinary skill in the art of preparing animal food treats may readily devise any number of suitable recipes for preparing an ingredient mixture useful in the pliable food treats and methods of the present disclosure after considering the present disclosure. Accordingly, a further detailed discussion of possible recipes is not considered necessary.

At step 504, the ingredient mixture may be extruded or otherwise processed into a pliable and relatively thin strip or square, rectangular, or elongate shape. In various embodiments, the ingredient mixture may be extruded into a pliable, substantially flat, relatively thin, rectangular, or substantially rectangular, strip. The strip may be of approximately the same width and thickness as the finished product, e.g., the rolled product 100. The extruding may be accomplished by any suitable manual or automated method. For example, the ingredient mixture may be extruded and/or formed using a cooker/extruder, such as one available from READCO MANUFACTURING.

At step 506, the flat, thin shape strip may be cut into sections having a length approximating the final unrolled length of the food treat 100. The cutting may be accomplished by any suitable manual or automated method. For example, the cutting may be performed by a suitable industrial extruder/former. At step 508, the sections may be formed into rolls. The rolling operation may be accomplished by hand, or may be partially or completely automated using an appropriate machine or piece of industrial equipment.

In various alternate embodiments, the ingredient mixture may be extruded or otherwise processed into rectangular sheets at step 504. The sheets may have a thickness approximating that of the rolled product 100. The sheets may then be cut into sections approximating the unrolled length of the rolled product 100 at step 506. The sections may be rolled according to any suitable method at step 508. The relatively wide rolled sections may be cut into individual rolled sections having a width approximating the width of the rolled product 100. Each rolled section may be a unitary rolled food treat, such as rolled product 100.

The rolled product 100, according to various embodiments, may be placed in a dispenser, for example, in one of containers 200, 300, 400 described above or other packaging. In any event, the thin article produced on processing the ingredient mixture must be pliable so that, whether or not cut into sections prior to rolling, the thin article or, if relevant, sections thereof may be formed into a roll without significant breakage occurring to the article or sections.

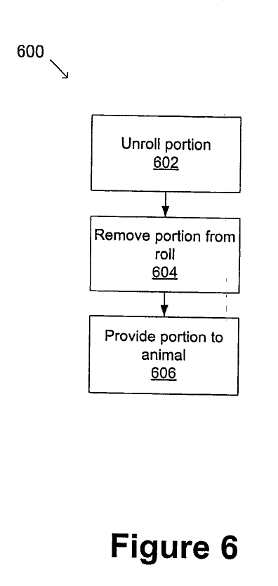

FIG. 6 is a flowchart schematically illustrating one non-limiting embodiment of a process 600 for providing a portion of food treat to an animal according to the present disclosure. At step 602, a desired length of the pliable rolled elongate animal food treat 100 described above is unrolled. The portion may, in various embodiments, be between one half of one inch and 6 inches, although the actual length of the unrolled portion is under the complete control of the person unwinding the treat. At step 604, the portion may be detached from the roll 100. For example, the portion may be ripped or torn from the rolled product 100. In various embodiments, the portion may be ripped or torn at indentations or perforations that may occur in the rolled product 100 at periodic intervals.

Also, in various embodiments, the desired length may be pulled from the rolled product 100 between the first section 202 and second section 204 of the container 200 (the roll product 100 will rotate within the container 200 as the desired length is pulled from the container 200). The container 200 may then be closed, forcing a region of the unrolled length of the rolled product 100 against the sharp edge 208, thus severing it from the remainder of the rolled product 100. It will be appreciated that a similar procedure may be performed using the container 300 or the container 400 to hold the rolled product 100. At step 606, the portion of the rolled product 100 detached from the rolled product 100 may be provided to the animal.

Unless otherwise indicated, all numbers expressing quantities of ingredients, dimension, time and so forth used in the present specification and claims are to be understood as being modified in all instances by the term “about.” Accordingly, unless indicated to the contrary, the numerical parameters set forth in the following specification and claims are approximations that may vary depending upon the properties sought to be obtained by the present invention.

While several embodiments of the invention have been described, it should be apparent that various modifications, alterations and adaptations to those embodiments may occur to persons skilled in the art with the attainment of some or all of the advantages of the present invention. For example, some steps of the process flows described above may be omitted or performed in a different order. It is therefore intended to cover all such modifications, alterations and adaptations without departing from the scope and spirit of the present invention as defined by the appended claims.

What is claimed is:

1. A method of preparing a food treat for an animal, the method comprising:
combining a plurality of ingredients to form an ingredient mixture;
processing at least a portion of the ingredient mixture into a pliable flat shape; and
forming the flat shape into at least one pliable roll.

2. The method of claim 1, wherein the plurality of ingredients comprises at least one meat product.

3. The method of claim 2, wherein the at least one meat product is selected from the group consisting of beef, chicken, turkey, tuna, lamb, bacon and pork.

4. The method of claim 1, wherein the plurality of ingredients comprises at least one vegetable product.

5. The method of claim 4, wherein the at least one vegetable product is selected from the group consisting of carrots and peas.

6. The method of claim 1, wherein the plurality of ingredients comprises at least one dairy product selected from the group consisting of milk, cheese and cream.

7. The method of claim 1, wherein:
processing the ingredient mixture into a flat shape comprises extruding the ingredient mixture.

8. The method of claim 1, wherein the flat shape is a narrow pliable strip.

9. The method of claim 1, wherein:
the flat shape is a substantially rectangular sheet; and
forming the flat shape into a pliable roll comprises rolling the flat shape into a single pliable roll, and cutting the single pliable roll into a plurality of narrower pliable rolls.

10. The method of claim 9, wherein the forming step is performed by an automated mechanism.

11. The method of claim 1, wherein the unrolled length of the pliable roll is between about 2 and 14 feet, the width of the pliable roll is between about one half of one inch and 4 inches, and the unrolled thickness of the pliable roll is between about one eighth of one inch and one half of one inch.

12. The method of claim 11, wherein the unrolled length of the pliable roll is three feet, the width of the pliable roll is one inch, and the unrolled thickness of the pliable roll is one eigth of one inch.

13. A container for holding food treat for an animal, the container comprising:
a first section, wherein the first section defines a first hollow cavity;
a second section, wherein the second section defines a second hollow cavity, and wherein the first hollow cavity and the second hollow cavity form an enclosed region when the first section and the second section are placed together; and
a pliable elongate rolled food treat positioned within the enclosed region.

14. The container of claim 13, wherein the first section and the second section are connected by a hinge, and wherein the first section is rotated relative to the second section about the hinge to either open the container and expose the pliable elongate rolled food treat, or close the container and enclose the pliable elongate rolled food treat.

15. The container of claim 13, wherein at least one of the first section and the second section comprises an edge that is at least one of sharp and serrated, and wherein the edge is adapted to contact a region of an unrolled portion of the pliable elongate animal food treat and thereby facilitate detaching the portion.

16. The container of claim 13, further comprising a belt clip connected to one of the first and second sections adapted to connect the container to clothing.

17. The container of claim 13, wherein one of the first section and the second section comprises a sleeve sized to fit within a hollow cavity in the other of the first section and the second section.

18. A container for holding food treat for an animal, the container comprising:
a hollow outer shell;
a slot defined by the hollow outer shell;
an edge adjacent to the slot, wherein the edge is at least one of serated and sharp;
a pliable elongate rolled food treat positioned within the enclosed region, wherein the slot is adapted to allow an unrolled portion of the pliable elongate rolled food treat to exit the hollow outer shell, and wherein the edge is adapted to remove the unrolled portion.

19. A method of providing a food treat to an animal, the method comprising:
unrolling a length of a pliable elongate rolled animal food treat;
detaching the length from the pliable elongate rolled animal food treat; and
providing the length to the animal.

20. The method of claim 19, wherein detaching the length comprises at least one of tearing the length from the pliable elongate rolled animal food treat, and cutting the length portion from the pliable elongate rolled animal food treat.

21. A food treat for an animal, the food treat comprising:
a pliable elongate shape formed from an ingredient mixture and having a length and a width, wherein the length is greater than the width, the elongate shape rolled along its length to provide a pliable rolled elongate animal food treat; and
wherein individual lengths may be unrolled and detached from the pliable rolled elongate animal food treat.

22. The food treat for an animal of claim 21, wherein the food treat comprises at least one ingredient selected from the group consisting of a meat product, a vegetable product and a dairy product.

23. The food treat for an animal of claim 21, wherein the length of the elongate strip is between about 2 and 14 feet when the pliable elongate animal food treat is unrolled, wherein the width of the elongate strip is between one half of one inch and 4 inches, and wherein the thickness of the elongate strip is between one eighth and one half of one inch.
